(19) United States
(12) Patent Application Publication
(10) Pub. No.: US 2015/0193284 A1
(43) Pub. Date: Jul. 9, 2015

(54) HOST/HOSTED HYBRID APPS IN MULTI-OPERATING SYSTEM MOBILE AND OTHER COMPUTING DEVICES

(71) Applicant: OpenMobile World Wide, Inc., Framingham, MA (US)

(72) Inventors: Thierno Diallo Hamzata, Framingham, MA (US); Jaap Vermeulen, Sterling, MA (US); Ashwin Bihari, Stow, MA (US); Onyeka Igabari, Framingham, MA (US); Kevin Menice, Stoughton, MA (US)

(21) Appl. No.: 14/516,913

(22) Filed: Oct. 17, 2014

Related U.S. Application Data
(63) Continuation-in-part of application No. 14/061,288, filed on Oct. 23, 2013.
(60) Provisional application No. 61/903,532, filed on Nov. 13, 2013.
(60) Provisional application No. 61/892,896, filed on Oct. 18, 2013.
(60) Provisional application No. 61/717,731, filed on Oct. 24, 2012.
(60) Provisional application No. 61/717,764, filed on Oct. 24, 2012.

(51) Int. Cl. G06F 9/54; G06F 9/50

(52) U.S. Cl. CPC G06F 9/546; G06F 9/5011

(57) ABSTRACT

According to further aspects of the invention, there is provided a computing device that executes a hybrid application in a single application address space established within a runtime environment defined under a native operating system executing on the device. That hybrid application includes (i) instructions comprising a “hosted” software application built and intended for execution under an operating system that differs from the native operating system, i.e., a hosted operating system, and (ii) instructions from at least one of a runtime library and another resource of the native runtime environment.

This application claims the benefit of priority of U.S. Patent Application Ser. No. 61/903,532, filed Nov. 13, 2013, entitled HOST-HOSTED HYBRID APPS IN MULTI-OPERATING SYSTEM MOBILE AND OTHER COMPUTING DEVICES. This application is a continuation-in-part of U.S. patent application Ser. No. 14/061,288, filed Oct. 23, 2013, entitled “MULTI-PLATFORM MOBILE AND OTHER COMPUTING DEVICES AND METHODS,” which claims the benefit of filing of U.S. Patent Application Ser. No. 61/892,896, filed Oct. 18, 2013, entitled MULTI-PLATFORM MOBILE AND OTHER COMPUTING DEVICES AND METHODS, U.S. Patent Application Ser. No. 61/717,764, filed Oct. 24, 2012, entitled BRIDGING NOTIFICATION SYSTEMS, and U.S. Patent Application Ser. No. 61/717,731, also filed Oct. 24, 2012, entitled SEMANTICALLY DIFFERENT TASK MANAGEMENT SYSTEM IN A SINGLE OPERATING SYSTEM. The teachings of all of the foregoing are incorporated herein by reference.

### BACKGROUND OF THE INVENTION

The invention pertains to digital data processing and, more particularly, to methods and apparatus for executing on a single hardware/software platform applications (“apps”) made for execution on multiple different such platforms. The invention has application in supporting cross-platform compatibility among apps for smart mobile devices, e.g., smart phones, tablet computers, set-top boxes, connected televisions, in-vehicle infotainment systems, or in-flight entertainment systems, and the like, all by way of non-limiting example.

The smart mobile device market has grown nearly 40% in the past year, according to analysts. This has been fueled, to a large degree, by the sale of devices running variants of the open-source Linux and Android operating systems. While a boon to the marketplace, those devices suffer as a result of the lack of cross-compatibility of the apps developed for them. Thus, for example, apps developed for mobile devices running the Meego operating system do not run on those executing the Tizen or Android operating systems. That problem is compounded, of course, when one turns to operating systems of entirely different lineages. For example, apps developed for Tizen do not run on those running WebOS or Windows OS's; and so forth.

This is not just a problem for consumers who have purchase new mobile devices that lack compatibility with old apps. It is also a problem for manufacturers, carriers and others in the supply chain whose efforts to deliver new hardware/software platforms are stymied by the lack of a large ecosystem of available apps. App developers, too, suffer from fragmentation in the marketplace, since they may be forced to port apps to a variety of platforms in order to establish or maintain product viability.

A few prior art efforts to resolve cross-compatibility issues have met with limited success. For example, Acer's Aspire One supported dual boot modes: one for Windows OS and one for Android. However, the device could not run apps for both operating systems in a single mode.

In view of the foregoing, an object of the invention is to provide improved systems and methods for digital data processing. Another, more particular, object is to provide such systems and methods as support executing on a single hardware/software platform applications (“apps”) made for execution on multiple different hardware/software platforms. Still another object is to provide such systems and methods as support cross-platform compatibility among apps for smart mobile devices, e.g., smart phones, tablet computers, set-top boxes, connected televisions, in-vehicle infotainment systems, or in-flight entertainment systems and the like, all by way of non-limiting example.

These and other objects are evident in the text that follows and in the drawings.

### SUMMARY OF THE INVENTION

According to further aspects of the invention, there is provided a computing device that executes a hybrid application in a single application address space established within a native operating system executing on the device. That hybrid application includes (i) instructions comprising a “hosted” software application built and intended for execution under an operating system that differs from the native operating system, i.e., a hosted operating system, and (ii) instructions from at least one of a runtime library and another resource of the native runtime environment.

Related aspects of the invention provide a computing device, e.g., as described above, in which the hybrid application that is executed in the single application address space additionally includes instructions from at least one of a runtime library and another resource of the hosted operating system.

Yet still further aspects of the invention provide a computing device, e.g., as described above, in which the hybrid application that is executed in the single application address space additionally includes instructions adapted from at least one of a runtime library and another resource of the hosted and/or native operating systems.

Still further aspects of the invention provide a computing device, e.g., as described above, in which the device effects creation and loading of the hybrid application for execution within the single application address space by executing instructions from at least two linker/loaders: one for the instructions of the native operating system (i.e., a native linker/loader), and one for the native instructions (a hosted linker/loader).

In related aspects, the invention provides a computing device, e.g., as described above, in which the instructions from the at least two linker/loaders are executed in the native runtime environment.

Other related aspects if the invention provide a computing device, e.g., as described above, in which the instructions of instructions comprising a software application built and intended for execution under an operating system that differs from the native operating system, i.e., a hosted operating system, and (ii) instructions from at least one of a runtime library and another resource of the native runtime environment.

Related aspects of the invention provide a computing device, e.g., as described above, in which the instructions of the hosted software application are suitable for execution on a central processing unit of the device.

Yet other aspects of the invention provide a computing device, e.g., as described above, in which creation and loading of the hybrid application is initiated upon selection for activation of a launch proxy corresponding to the hosted software application. According to some aspects of the invention, that launch proxy includes one or more of:
Instructions to link and load and execute the hosted software application using the hosted linker/loader and, then, to execute the hosted software application.
References to one or more “adapted” libraries that (i) contain at least selected classes and/or functions (collectively, “functions”) of the hosted runtime libraries and/or other resources of a hosted runtime environment called and/or potentially called by the hosted software application executable and (ii) resolve in calls to native runtime libraries.
References to one or more libraries containing other functions, if any, of the hosted runtime libraries called and/or potentially called by the hosted software application executable.
References to one or more native runtime libraries and/or native runtime environments 16 resources.
Instructions for executing the hosted linker/loader with native runtime environments to link hosted software application and to resolve references therein using (1)-(4).

### BRIEF DESCRIPTION OF THE DRAWINGS

A more complete understanding of the invention may be attained by reference to the drawings, in which:

FIGS. 1A-1C depict a computing device of the type embodying the invention;

FIG. 2 depicts a native operating system of the type executing in the device of FIG. 1;

FIG. 3 depicts one or more hosted runtime environments defined by a native software application for execution of hosted software applications in the device of FIG. 1;

FIG. 4 depicts the interaction of components in launching an exemplary hosted software application based on user interaction with that application's launch proxy executing in a native runtime environment, displaying an application window representing operation of the hosted software application via that application's IO proxy, and transmitting user input from that proxy back to the hosted application;

FIG. 5 is a block diagram illustrating task operations in both the hosted application runtime environment and the native application runtime environment, and a one-to-one correspondence between hosted application tasks and proxy tasks, in accordance with an embodiment of the invention;

FIG. 6 is a block diagram illustrating the relationships between proxy tasks in the native application runtime environment and the complex task models and virtual frame buffer of the hosted application runtime environment, according to the task switching method of FIG. 8;

FIG. 7 is a flow chart illustrating a task switching method occurring in both the hosted application runtime environment and the native application runtime environment of the device of FIG. 5, in accordance with an embodiment of the invention;

FIG. 8 depicts interaction of the notification subsystems of the hosted runtime environments and native runtime environments in a system according to the invention

FIG. 9 depicts a notification translation function in a system according to the invention;

FIGS. 10-12 are flowcharts depicting notification translation in a system according to the invention;

FIG. 13 depicts a hybrid collection of instructions for execution a single application address space—or, more simply put, execution of a “hybrid” application 2000—according to some embodiments of the invention; and

FIG. 14 is a flow chart depicting operation of a computing device in creating and executing a hybrid application in native runtime environments in a system according to one practice of the invention.

### DETAILED DESCRIPTION OF THE ILLUSTRATED EMBODIMENT

### Architecture

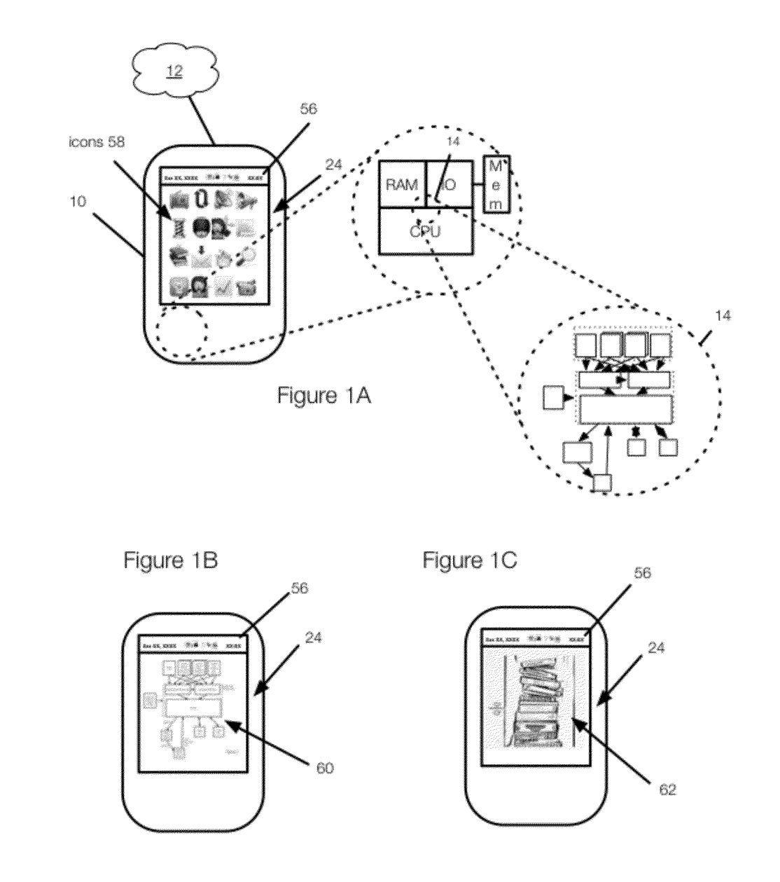

FIG. 1A depicts a computing device 10 of the type embodying the invention. The illustrated device 10 includes a central processing unit (CPU), input/output (I/O), memory (RAM) and nonvolatile storage (MEM) subsections, of the type commonly provided computing devices of the type commercially available in the marketplace, all as adapted in accord with the teachings hereof. In the illustrated embodiment, the device 10 comprises a mobile computing device, such as a smart phone or tablet computer, though, in other embodiments it may comprise other computing devices, mobile or otherwise, e.g., a set-top box, connected television, in-vehicle infotainment system, or in-flight entertainment system, just to name a few.

The device 10 may be connected permanently, intermittently or otherwise to one or more other computing devices, servers, or other apparatus capable of digital communications (not shown) by a network, here, depicted by “cloud” 12, which may comprise an Internet, metropolitan area network, wide area network, local area network, satellite network, cellular network, point-to-point network and/or a combination of one or more of the foregoing, in the conventional manner known in the art, as adapted in accord with the teachings hereof.

The CPU of device 10 (e.g., in conjunction with the I/O, RAM and/or MEM subsections) executes a native operating system 14 of the type commercially available in the marketplace, as adapted in accord with the teachings hereof. Examples of such operating systems include the Meego, Tizen, Android, WebOS, and Linux operating systems, to name just a few. More generally and/or in addition, the native operating system 14 can be a Linux-based operating system, such as, by way of nonlimiting example, an Android-based operating system.

Native Runtime Environment(s)

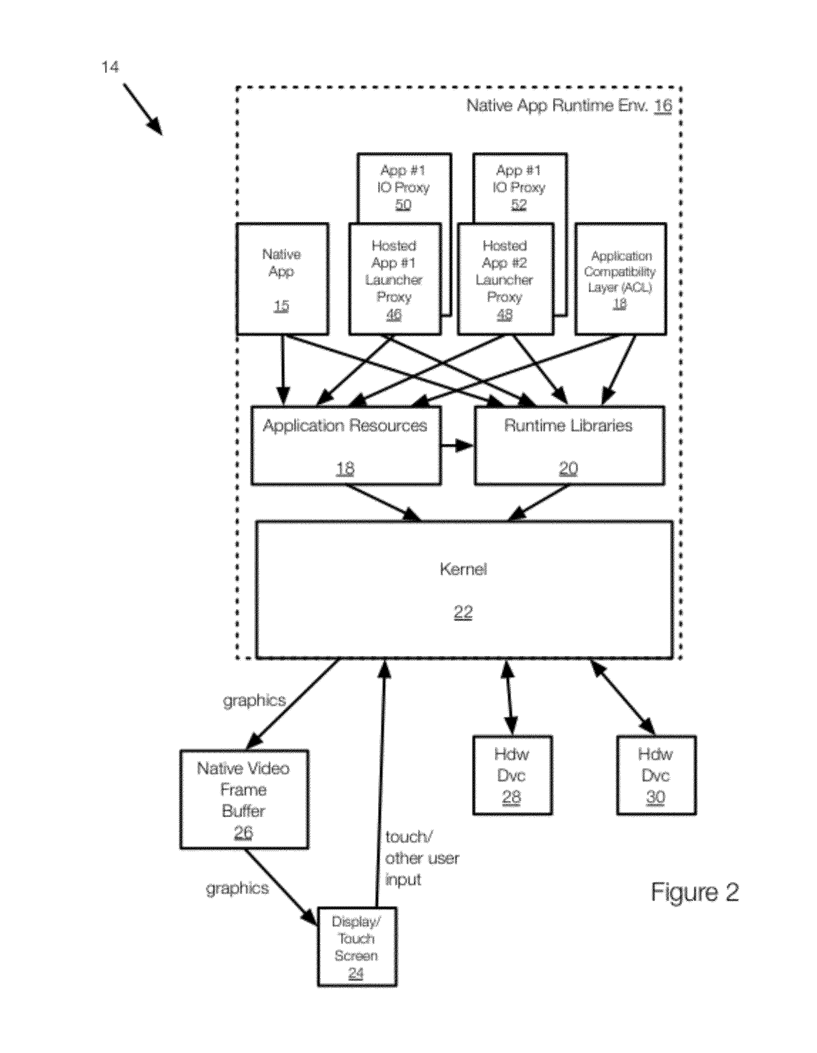

FIG. 2 depicts a native operating system 14 of the type executing on illustrated device 10 of FIG. 1.

Referring to that drawing, the native operating system 14 defines one or more native runtime environments 16 of the type known in the art (as adapted in accord with the teachings hereof) within which native software applications of the type known in the art (as adapted in accord with the teachings hereof)—i.e., applications having instructions for execution under the native operating system—are executing. Such applications are labeled 15, 18 and 46-52 in the drawing. As used here and elsewhere herein, the terms “application” and “app” are used interchangeably.

The native runtime environment(s) 16 may comprise one or more virtual machines or otherwise, as is conventional in the art (as adapted in accord with the teachings hereof), depending on the native operating system 14 and the specifics of its implementation on device 10. Illustrated native runtime environment 16 includes, by way of nonlimiting example, application resources 18 and runtime libraries 20, all of the type known in the art, as adapted in accord with the teachings hereof. That runtime environment 16 also includes a kernel 24 of the type known in the art, as adapted in accord with the teachings hereof.

Kernel 24 (or alternate functionality provided in the runtime environment(s) of alternate embodiments) serves inter alia as an interface, in the conventional manner known in the art has adapted in accord with the teachings hereof, between CPU 12 (and, more typically, the native applications executing within the native runtime environment 16 executing thereon) and hardware devices 24-30 integral or attached to device 10. This includes display/touch screen 24 and the frame buffer 26 that drive displays thereon in the conventional manner known in the art, as adapted in accord with the teachings hereof. This can also include, by way of non-limiting example, a keyboard, trackball, touch stick, other user input devices, and/or other integral or peripheral devices of the type known in the art. In the discussion that follows, the display/touch screen 24, the frame buffer 26, and other integral/peripheral devices supporting interactions between the device 10 and its user are referred to as a “hardware interface,” regardless of whether they comprise hardware, software or (as is more typically the case) a combination thereof.

A native software application 18, referred to, here, without intent of limitation, as the “Applications Control Layer” or “ACL”, executing within the one or more native runtime environments 16 defines one or more hosted runtime environments within which hosted software applications are executing. Each such hosted software application has instructions for execution under a hosted operating system that differs from the native operating system.

Native software applications 46-52 are proxies of hosted software applications 34, 36. Particularly, in the illustrated embodiment, each hosted software application executing in hosted runtime environment 32 has two corresponding proxies executing in the executing in native runtime environment 16: a launch proxy and an IO proxy. Here, the proxies of hosted software application 34 are launch proxy 46 and IO proxy 50. The proxies of hosted software application 36 are launch proxy 48 and IO proxy 52. Although, both launch and IO proxies are used in the illustrated embodiment, in other embodiments hosted software applications may have corresponding proxies of only one type (e.g., 10 or launch) or otherwise.

Hosted Runtime Environment(s)

The hosted operating system can be, for example, a Linux-based operating system, such as, by way of nonlimiting example, an Android-based operating system. The native operating system 14 can likewise be, for example, a Linux-based and/or Android-based operating system, albeit, of a different “flavor” than that of the hosted operating system. By way of more particular example, where the native operating system 14 comprises one of the aforementioned Tizen, WebOS, Linux operating systems (as adapted in accord with the teachings hereof), by way of nonlimiting example, the hosted operating system can comprise a “flavor” of the commercially available Android operating system (as adapted in accord with the teachings hereof), again, by way of nonlimiting example.

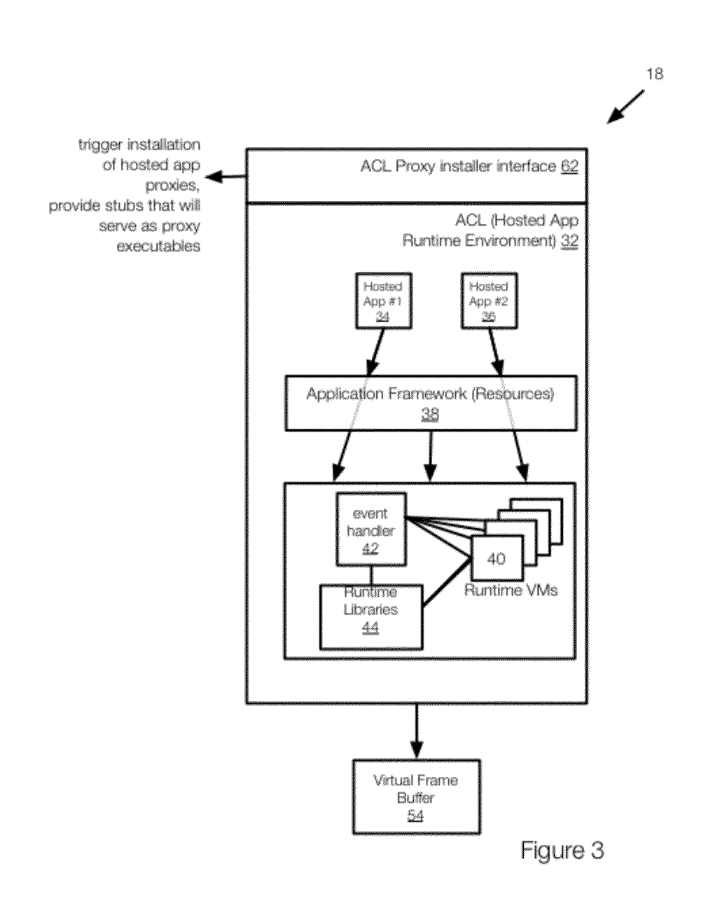

FIG. 3 depicts the one or more hosted runtime environments 32 defined by the native software application 18 (or ACL) for execution of hosted software applications 34, 36 in the device 10 according to the invention. The illustrated hosted runtime environment 32 is of the type known in the art (as adapted in accord with the teachings hereof) within which software applications having instructions for execution under the hosted operating system (i.e., hosted software applications) are built and intended to be executed.

The hosted runtime environment(s) 32 may comprise one or more virtual machines or otherwise, as is conventional in the art (as adapted in accord with the teachings hereof), depending on the type of the hosted operating system and the specifics of its implementation within the runtime environments 32. Illustrated hosted runtime environment 32 is intended for executing Android-based software applications 34, 36 (though, other embodiments may be intended for executing applications designed and built for other operating systems) and includes, by way of non-limiting example, a resource framework 38, virtual machines (VMs) 40, event handler 42 and run-time libraries 44, all by way of non-limiting example and all of the type known in the art, as adapted in accord with the teachings hereof.

The illustrated runtime environment 32 does not include a kernel per se (as might normally be included, for example, in the runtime environment of a Linux-/Android-based operating system) in the sense of running operations in a protected, kernel space of the type known in the art. Instead, some such operations (e.g., operations that might normally be included, for example, in the kernel of a Linux-/Android-based operating system) are executed in user space.

By way of example, are those kernel space operations relied upon by the resource framework 34, virtual machines (VMs) 36, event handler 42, run-time libraries 44, and/or other components of the runtime environment 32 to load graphics to a frame buffer for presentation on a display. Rather than executing in a kernel of hosted runtime environment 32, in the illustrated embodiment those operations are elevated to user space and are employed to load such graphics to a “virtual” frame buffer 54, which (as discussed below) is shared with the native runtime environment 16 and the applications executing there—particularly, the I/O proxy applications 50, 52.

The execution of other such kernel-space operations is avoided by passing-off to native operating system 14 and its runtime environment 16 operations and, more broadly, functions required for execution of hosted software applications 34, 36 that would otherwise be performed within the runtime environment 32 and, specifically, for example by a kernel thereof.

Such passing-off, in the illustrated embodiment, is effected, for example, by the resource framework 34, virtual machines (VMs) 36, event handler 42, run-time libraries 44, and/or other components of the runtime environment 32, which communicate with and/or otherwise rely on the native software application proxies 46-52 (executing in runtime environment 16) of hosted software applications 34, 36 to perform such functions or alternates thereof.

A further appreciation of the foregoing maybe attained through the discussion that follows and elsewhere herein.

Native and Hosted Software Application Installation

Native software applications, e.g., 15 and 18, are installed (upon direction of the user or otherwise) on device 10 and, more particularly, for execution within native runtime environments 16, in the conventional manner of the art for installations of apps within operating systems of the type of operating system 14. Such installation typically involves cooperative action of hosted operating system 14 and the runtime environments 16 executing an “installer” app (not shown) of the type conventional to OS 14 and typically includes unpacking, from an applications package file (e.g., downloaded from a developer site or otherwise), the to-be-installed application's executable file, icon file, other support files, etc., and storing those to designated locations in static storage (MEM) on device 10, again, in the conventional manner known in the art.

Host software applications 34, 36 are installed (upon direction of the user or otherwise) under control of ACL 18 for execution under hosted runtime environments 32. To that end, the ACL 18 can utilize an installer app the type conventional to the hosted operating system, albeit, modified to unpack from the application package files, or otherwise, the to-be-installed application's executable file, icon file, other support files, etc., to suitable locations in static storage (MEM) on device 10, e.g., locations dictated by native operating system 14, yet, consistent with the hosted operating system, or otherwise.

Unlike other native software applications, e.g., 15 and 18, the native software applications 46-52 that are proxies of a hosted software application 34, 36 are installed, by request from ACL 18 to native operating system 14, in connection with the installation by ACL 18 of each respective hosted software application. Each such proxy 46-52 is installed by the native operating system 14 in the conventional manner, albeit, from application package files (or otherwise) generated by ACL's 18 proxy installer interface 62.

Those package files can include, in lieu of the respective hosted software application 34, 36 executable, a “stub” executable suitable for
(ii) execution under native operating system 14 and, particularly, within native runtime environments 16,
(ii) effecting the functions discussed below (and elsewhere herein) attributable to the launch proxies and the IO proxies, respectively.

Those package files can also include icon files that are identical to or variants of those originally supplied with the application package files (or otherwise) for the respective hosted software applications 34, 36. Although, in the illustrated embodiment, two proxies may be associated with each hosted software application, only a single icon is associated with both proxies as displayed on the graphical desktop, e.g., of FIG. 1A.

Multi-Operating System Mobile and Other Computing Devices

The computing device 10 supports the seamless execution of applications of multiple operating systems—or, put another way, it “merges” the user experience so that applications executed in the hosted runtime environment appear, to the user, as if they are executing within the native operating system 14.

Thus, for example, application windows representing execution of the hosted software applications are presented to the user without interfering with the status bar that forms part of the “desktop” generated as part of the overall graphical user interface by the native operating system 14 and/or native runtime environment 16, thus, making the hosted software applications appear similar to native software applications. This is shown, by way of example, in FIGS. 1A-1C.

Referring to FIG. 1A, the native operating system 14 drives the computing device to display, on display/touch screen 24, a graphical desktop with icons 58 representing applications that can be selected for launch or other activation by the user of the device 10. In the illustrated embodiment, these can be native software applications, e.g., 15, and hosted software applications, e.g., 34, 36.

That desktop display includes a status bar 56 of the type conventional in the art—and, particularly, conventional to native operating system 14 (although, some embodiments may vary in this regard). Here, that status bar 56 indicates the current date/time, carrier conductivity signal strength (e.g., Wi-Fi, cellular, etc.), active apps, and so forth., though, in other embodiments, it may indicate other things.

Referring to FIG. 1B, when a native software application, e.g. 15, is activated by the operating system 14 and/or runtime environments 16 in response to user selection, the application window 60 generated for it by the native runtime environment 16 (reflecting execution of the application) for presentation on the screen 24 occupies that screen along with the status bar 56—here, particularly, with the status bar 56 on the top fraction of the screen and the application window 60 on the remainder. Put another way, the the operating system 14 and/or runtime environments 16 do not overwrite the status bar 56 with the applications window 60. (Of course, it will be appreciated that this is the default mode of operation of the operating system 14 and/or runtime environments 16, and that in other modes, e.g., so called “full screen” modes, the application window 60 may occupy the entirety of the screen).

Referring to FIG. 1C, likewise, in the illustrated embodiment, when a hosted software application 34, 36 is activated, the application window generated for it (reflecting execution in the hosted runtime environments 32) is presented identically on the screen 24 as that of a native software application—that is, it is presented without overwriting the status bar 56 (e.g., at least when displaying in default mode).

Another example of the illustrated computing device's 10 merging the user experience so that applications executed in the hosted runtime environment appear, to the user, as if they are executing within the native operating system 14 is the use of a common notification mechanism, e.g., that of the native operating system 14 and/or runtime environments 16.

Still another example is the consistent activation of running software applications in response to user replies to notifications (and otherwise), whether they are native applications, e.g., 15, or hosted software applications 34, 36.

Still other examples will be evident to those skilled in the art from the discussion that follows and otherwise.

Hosted Application Display in Multi-Operating System Mobile and Other Computing Devices

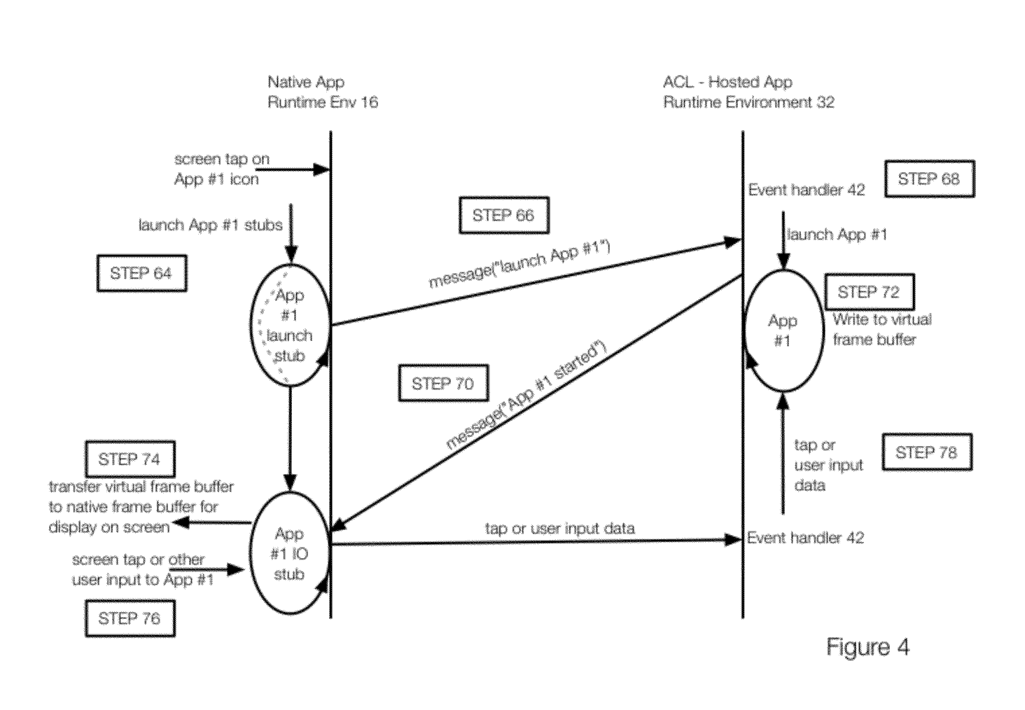

A further understanding of the operation of device 10 in these regards may be appreciated by reference to FIG. 4, which depicts the interaction of the components discussed above in launching an exemplary hosted software application 34 (here, labelled “App 1”) in hosted runtime environments 32 based on user interaction with that app's launch proxy 46 (here, labelled “App #1 Launch Stub”) executing in native runtime environments 16, displaying an application window representing operation of hosted software application 34 via that app's IO proxy 50 (here, labelled “App #1 IO Stub”), and transmitting user input from that proxy 50 back to the app 34.

Prior to illustrated step 64, native runtime environments 16 (and/or native operating system 14) present on the above-described graphical desktop (see, e.g., FIG. 1A) icons 58 representing native and hosted software applications that can be selected for launch or other activation by the user of the device 10. As noted above, those icons are provided to native runtime environments 16 and/or native operating system 14 in connection with installation of the respective apps.

As per convention of operating systems of the type of native operating system 14, the native software application that is launch proxy 46 is launched by native runtime environments 16 and/or native operating system 14 upon its selection for activation by the user. See, step 64. Proxy 50 can be simultaneously launched by native runtime environments 16 and/or native operating system 14; alternatively, proxy 50 can be launched by proxy 46 upon its launch. Id.

Upon launch (or other notification of activation from native runtime environments 16 and/or native operating system 14), proxy 46 effects activation of corresponding hosted software application 34. See, step 66.

In the illustrated embodiment, proxy 46 does this by transmitting a launch message to the event handler 42 that forms part of the hosted runtime environments 32 and that is common to the one or more hosted software applications 34, 36 (e.g., in that it is the common, shared recipient of system level-events, such as user input to the hardware interface, which events it distributes to appropriate hosted applications or other software executing in the hosted runtime environments 32 or provided as part of the hosted operating system). The launch message, which can be delivered to event handler 42 by proxy 46 using any convention mechanism for inter process communication (IPC), e.g., APIs, mailboxes, etc., includes an identifier of the proxy 46 and/or its corresponding hosted software application 34, as well as any other information required by the hosted operating system and/or hosted runtime environments 32 to effect launch of a hosted software application.

In step 68, the event handler 42 launches the hosted software application 34 in the conventional manner required of hosted operating system and/or the hosted runtime environments 32. Put more simply, that app 34 is launched as if it had been selected by the user of device 10 directly.

Following launch of hosted software application 34, event handler 42 uses IPC, e.g., as described above, to signal that hosted software application 34 has begun execution and, more aptly, to insure launch (if not already effected) and activation of proxy application 50 with the native runtime environments 16. See, step 70.

Following launch, hosted software application 34 runs in the conventional manner within hosted runtime environments 32 and makes such calls to the hosted resource framework 38, hosted event handler 42 and run-time libraries 44, all by way of non-limiting example, as it would otherwise make if it were installed on a device executing a single operating system of the type of the hosted operating system. This is advantageous in that it does not require special recoding (i.e., “porting”) of the hosted software application 34 by the developer or publisher thereof in order to make it possible to run in the multi-operating system environment of device 10.

Hosted resource framework 38, hosted event handler 42 and run-time libraries 44, and the other components of hosted runtime environments 32 respond to such calls in the conventional manner known of operating systems of the type of hosted operating system, except insofar as evident from the teachings herein. Thus, for example, as noted above, some such operations (e.g., those for loading frame buffers) of the type that might normally be executed in a privileged kernel space by hosted runtime environments 32 are, instead, executed in user space. And, other such operations or, more broadly, functions are passed-off to native operating system 14 and its runtime environment 16, e.g., via the proxies 46-52.

By way of example, in lieu of loading an actual frame buffer with graphics defining an applications window representing execution of the hosted software application 34, the hosted runtime environment 32 loads the virtual frame buffer 54 with such graphics. See, step 72. The hosted runtime environment 32 effects this through use of windowing subsystem that forms part of the hosted runtime environment 32 and that is common to the one or more hosted software applications 34, 36 (e.g., in that it is the common, shared system used by the hosted software applications for generating applications windows for display to the user of device 10.)

The IO proxy 50 of hosted software application 34 effects presentation on screen 24 of the applications windows generated for application 34 by hosted runtime environments 32, e.g., in the manner shown in FIG. 1C and discussed in connection therewith above. See, step 74. IO proxy 50 does this by transferring the graphics defining that applications window from virtual frame buffer 54 to the native frame buffer 26, e.g., using an API provided by native runtime environments 16 for such purpose or otherwise. Although in some embodiments, the hosted runtime environments 32 utilizes messaging to alert 10 proxy 50 of the need for effecting such a transfer, e.g., when the window subsystem of hosted runtime environments 32 has generated an updated applications window for hosted software application 34, when hosted software application 34 becomes the active (or foreground) app in hosted runtime environments 32, or otherwise, in other embodiments IO proxy 50 effects such transfers on its own accord on a periodic basis or otherwise.

User/Hosted Application Interaction in Multi-Operating System Mobile and Other Computing Devices

IO proxy 50 utilizes a mechanism paralleling that discussed above in connection with steps 64-68 in order to transmit taps and other input made by the user to device 10 and specifically, for example, to display/touch screen 24, a keyboard, trackball, touch stick, other user input devices. In this regard, a common event handler (not shown) or other functionality of native runtime environments 16 notifies applications executing within them, including the IO proxies 50, 52, of user input made with respect to them via the touch screen 24 or those other input devices. Such notifications are made in the conventional manner known in the art of operating systems of the type of native operating system 14, as adapted in accord with the teachings hereof.

When IO proxy 50 receives such a notification, it transmits information with respect thereto to its corresponding hosted software application 34 via event handler 42, e.g., in a manner similar to that discussed above in connection with step 66. See, step 76. That information, which can be delivered to event handler 42 by IO proxy 50 using any conventional IPC mechanism, can include and identifier of the IO proxy 50 and/or its corresponding hosted software application 34, an identifier of the device to which input was made, the type of input, and relevant information with respect thereto (e.g., location, time, duration and type of touch, key tapped, pressure on pointer, etc.). That information is received by event handler 42 and applied to the corresponding hosted software application 34 in the conventional manner required of hosted operating system and/or the hosted runtime environments 32, e.g., as if the touch or other user input had been made directly to hosted software application 34. See, step 78.

Coordination of Foreground Application Tasks in Multi-Operating System Mobile and Other Computing Devices

Native runtime environments 16 responds to activation of an executing native application, e.g., via user selection of the corresponding applications window or icon on the desktop of display 24, or otherwise, by bringing that applications window to the foreground and making it the active task with which the user interacts (and to which user input is directed). Similar functionality is provided by the event handler 42 of hosted runtime environments 32, albeit with respect to executing hosted software applications, with respect to a virtual desktop residing on virtual frame buffer 54, and with respect to virtual user input devices.

In order to more fully merge the user experience so that applications executed in the hosted runtime environments 32 appear, to the user, as if they are executing within the native operating system 14, when IO proxy 50 is brought to the foreground of the graphical user interface presented on the aforementioned desktop by the windowing subsystem of native runtime environments 16 (e.g., as a result of a user tap on the application window for IO proxy 50, as a result of issuance of a notification with respect to that application or otherwise), that IO proxy 50 effects making the corresponding hosted software application 34 active within the one or more hosted runtime environments 32, as if it had been brought to the foreground in them.

An understanding of how this is effected in the illustrated embodiment may be attained by reference to the discussion that follows, in which:
the term “task” is used in place of the term “application”;
the term “interactive task” is used in reference to an application for which an applications window is generated as part of the graphical user interface of the respective operating system and/or runtime environment reflecting execution that application;
the term “foreground task” is used in reference to an application with which the user of device 10 is currently interacting;
the term “simple interactive task” refers to an application running in one process;
the term “complex interactive task” refers to an application running in more than one process; and
although a differing elemental numbering scheme is used, like names are used for like components discussed above and shown in FIGS. 1-4.

The teachings below provide for managing tasks (i.e., applications) where the designation of a foreground task in the hosted application runtime environment 32 is independent of the designation of a foreground task in the native application runtime environment 16, and where tasks in the hosted application runtime environment 32 may (or may not) span multiple processes.

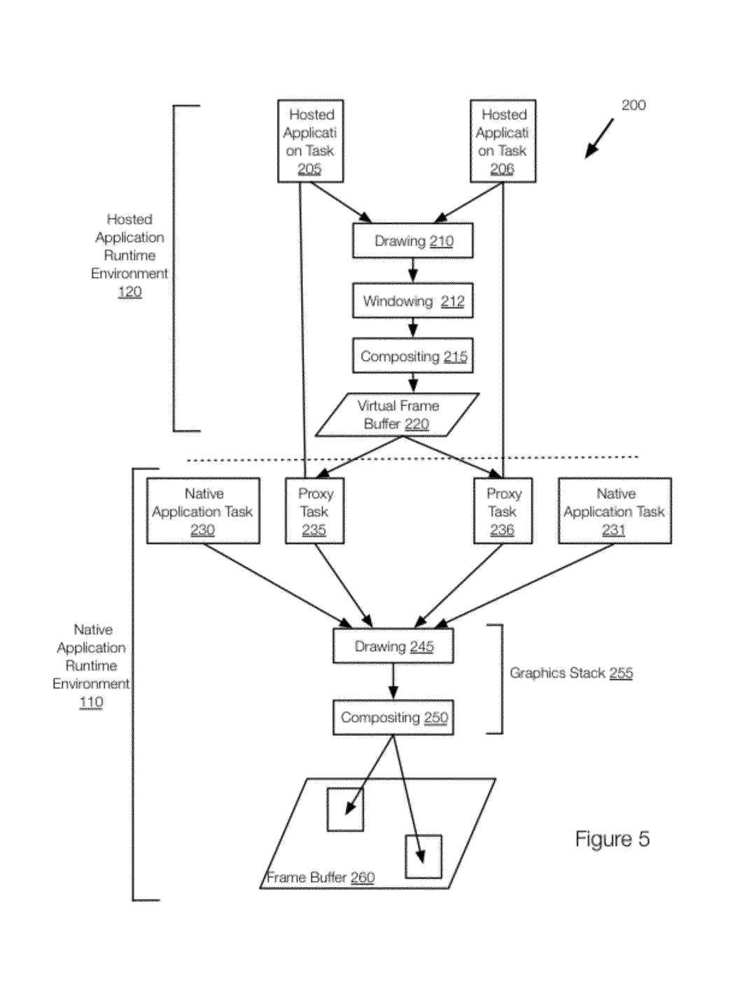

With reference to FIG. 5, in accordance with the illustrated embodiment of the invention, native application tasks in operating systems with simple task models (such as native operating system 105) are each associated with a single process. Interactive native application tasks 230, 231 are further differentiated from non-interactive tasks (not shown) by their utilization of the graphics stack 255 of the native application runtime environment 110. The graphics stack 255, comprised of drawing module 245 and compositing module 250, updates the contents of the native frame buffer 260 with the visual portions of the foreground task for display to a user via display/touch screen 24.

Hosted (or non-native) application tasks 205, 206 reside within the hosted application runtime environment 120. If the hosted application runtime environment 120 employs a different task model than the native operating system 105, each hosted application task 205, 206 is associated with a proxy (or client) task 235, 236, respectively. The proxy tasks 235, 236 reside within the native application runtime environment 110 along with the native application tasks 230, 231, and are managed by the same native task management system in the native application runtime environment 110 as the native application tasks 230, 231.

The proxy tasks 235, 236 monitor the state (foreground or background) of the hosted application tasks 205, 206, and enable the hosted application tasks 205, 206 to be fully functional within the device 100, despite the differences between the application runtime environments 110 and 120. In the illustrated embodiment, proxy tasks are created when the hosted tasks are created, but this is not a limitation of the invention.

Hosted application runtime environment 120 comprises a drawing module 210, a windowing module 212, and a compositing module 215, that together provide the visual portions of the hosted application tasks 230, 231 to the virtual frame (or screen) buffer 220.

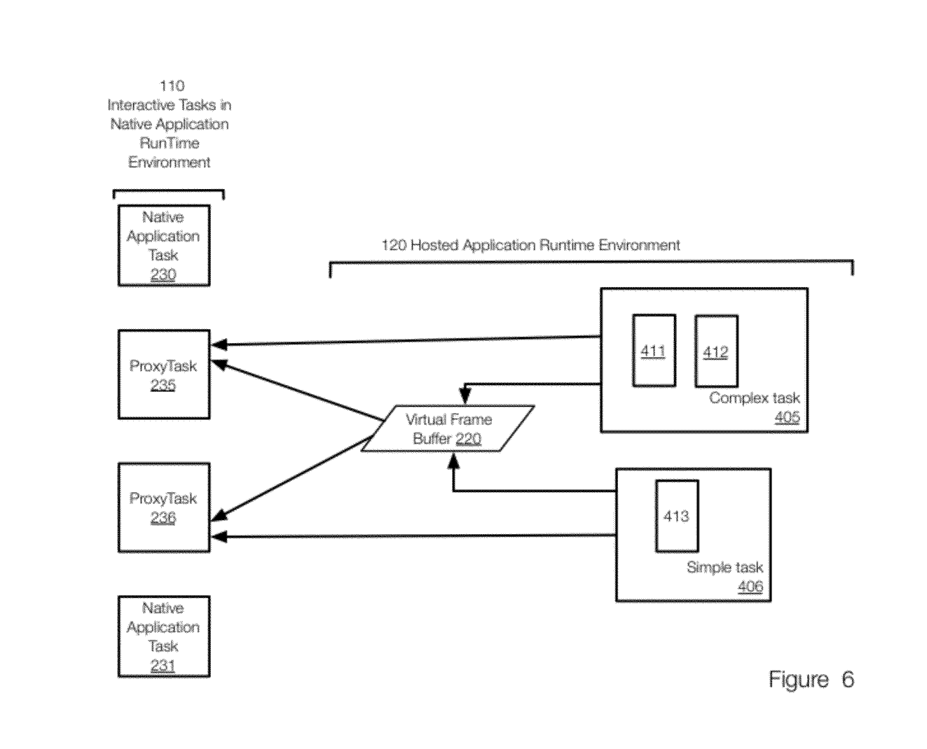

As shown in FIG. 6, hosted application runtime environment 120 further comprises a task 405 operating in accord with the complex task model and having two processes 411, 412, and a task 406 operating in accord with the simple task model and having one process 413). Regardless, in the illustrated embodiment, each of the tasks 405, 406 is associated with one proxy (or client) task 235, 236 respectively, and also associated with one hosted application 205, 206 respectively.

Together, the proxy (or client) tasks 235, 236, the task models 405, 406, the hosted system of drawing 210, windowing 212, and compositing 215 modules, and the virtual frame (or screen) buffer 220, provide the following functions: (i) enabling the hosted application tasks 205, 206 to run as background tasks within the native application runtime environment 110; (ii) enabling the hosted application runtime environment's 120 foreground status to be abstracted from the operation and semantics of the task management system in the native application runtime environment 110; and (iii) integrating and coordinating the operation of the hosted application runtime environment 120 and the native application runtime environment 110 such that the user cannot discern any differences between the functioning of the native application tasks 230, 231 and the hosted application tasks 205, 206.

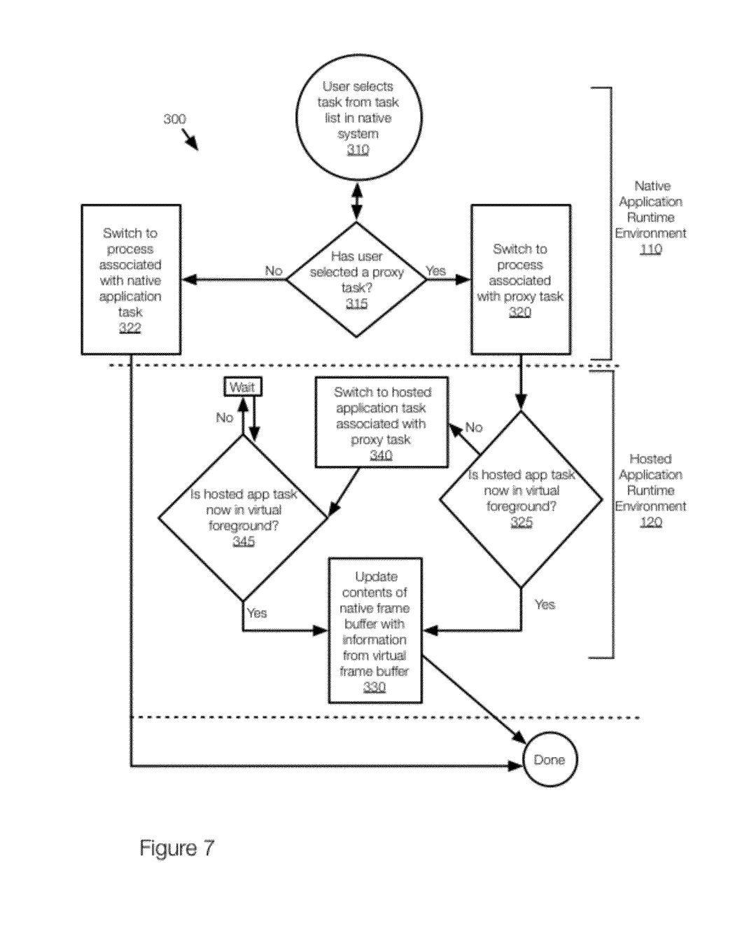

FIG. 7 illustrates the method of switching between interactive tasks and, more particularly, of coordinating foreground/active tasks, as between the native and posted runtime environments, in accordance with a preferred embodiment of the invention. In particular, FIG. 7 illustrates how the task displayed in the virtual frame buffer 220 of the hosted application interface environment 120 is coordinated with its corresponding proxy task and the foreground task of the native application runtime environment 110.

In step 310, the user selects an interactive task from the task list in the native system.

Both native application tasks 230, 231 and proxy tasks 235, 236 (as stated above and shown in FIG. 6, proxy tasks 235, 236 are tasks within the native application runtime environment 230 that act as proxies for hosted application tasks 205, 206 respectively), are available in the task list for selection by the user. At step 315, the method determines whether the user has selected a proxy task or a native application task. Proxy tasks are distinguished from native application tasks by convention. Any property where a value or a string can be modified can be used, by convention, to identify a proxy task. In a preferred embodiment, task names are used to distinguish between proxy tasks and native application tasks, although this is not a limitation of the invention.

If the user selects a native application task (i.e., one of 230, 231) at step 315, the method proceeds to step 322. At step 322, the native application runtime environment 110 switches to the process associated with the selected native application task, and brings the selected native application task to the foreground of the native application runtime environment 110.

Alternatively, if the user selects a proxy task (i.e., one of 235, 236) at step 315, the method proceeds to step 320. At step 320, the native application runtime environment 110 switches to the process associated with the selected proxy task (e.g., as discussed elsewhere herein) and brings the selected proxy task to the foreground of the native application runtime environment 110.

At this point, the task switch has occurred in the native application runtime environment 110, and may need to be propagated to the hosted application runtime environment 120. At step 325, the method determines whether or not the task switch needs to be propagated to the hosted application runtime environment.

At step 325, the method determines whether the hosted application task is in the virtual foreground of the hosted application runtime environment 120. This determination is made using information obtained by the proxy task 235, 236 about the state of the virtual frame buffer 220 in the hosted application runtime environment 120. Specifically, the proxy tasks monitor the state (foreground or background) of the hosted application tasks.

If the hosted application task is in the virtual foreground of the hosted application runtime environment 120, the task switch does not need to be propagated, and the method proceeds to step 330. At step 330, the hosted application task's view of the virtual frame buffer 220 is updated to the native frame buffer 260. At this point, the hosted application task is in the foreground, and the user will be able to view and make use of the user-selected task. The seamless transition allows the user to view the hosted application task 205, 206 as if viewing a native application task.

Referring again to step 325, if the hosted application task is not in the virtual foreground of the hosted application runtime environment 120, the task switch needs to be propagated, and the method proceeds to step 340. At step 340, the hosted application runtime environment 120 switches to the hosted application task 205, 206 associated with the proxy task 235, 236 as described in step 320.

At step 345, the method determines whether the hosted application task 205, 206 is now in the virtual foreground of the hosted application runtime environment 120. If the hosted application task is not in virtual foreground of the hosted application runtime environment 120, the method waits until the hosted application task moves to the virtual foreground of the hosted application runtime environment 120. At this point, the method proceeds to step 330, as described above.

Notification and Reply Adaptation for Hosted Applications in Multi-Operating System Mobile and Other Computing Devices

As noted above, another example of the illustrated computing device's 10 merging the user experience so that applications executed in the hosted runtime environment appear, to the user, as if they are executing within the native operating system 14 is the use of a common notification mechanism, e.g., that of the native operating system 14 and/or runtime environments 16.

An understanding of how this is effected may be attained by reference to the discussion that follows, in which
It will be appreciated that, as a general matter of background, some computer operating systems have notification systems, where applications native to those operating systems post notifications. Users can interact with those notifications, and the interactions are conveyed to the applications that posted those notifications. Unlike applications, notification systems are singletons—there is one per (operating) system;
In the illustrated embodiment, the foregoing is likewise true of the native operating system 14 and, more particularly, of the native runtime environment 16—there is a single notification subsystem that is common to all executing native software applications;
In the illustrated embodiment, the foregoing is likewise true of the hosted operating system and, more particularly, of the hosted runtime environments 32—there is a single notification subsystem that is common to all executing hosted software applications;
The native and hosted operating systems are assumed to have diverse implementations of notification systems: Each might have a different set of standard prompts, visual indicators, and interprocess messages, on different interprocess message systems, used to notify applications of user interactions with notifications;
It is assumed that it would be confusing to the user of device 10 if notifications were presented from two different notification systems, e.g., some from the notification subsystem of the native operating system and some from the notification subsystem of the hosted operating system;
Although a differing elemental numbering scheme is used, like names are used for like components discussed above and shown in FIGS. 1-7

Described below is a mechanism for enabling hosted applications to use and interact with native system notification subsystems.

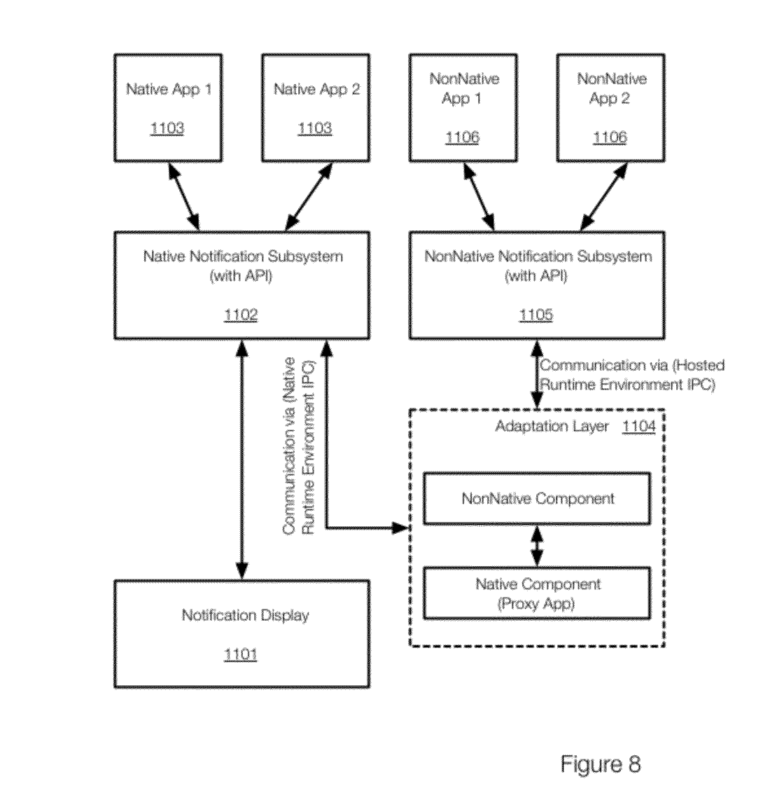

Referring to FIG. 8, native operating system 14 has a notification subsystem 1102 that provides a visual display of notifications 1101. Applications 1103 post notifications, using an API of subsystem, 1102, and, optionally, can interact with notifications by specifying that they be notified of touches and other user actions through that API, which may use inter-process communication to convey the information about interactions to the application.

Similarly, hosted runtime environments 32 provides a notification subsystem 1105 that is employed by hosted (nonnative) apps 1106. Those applications post notifications, using an API of subsystem 1105, and, optionally, normally interact with notifications by specifying that they be notified of touches and other user actions through that API, which may use inter-process communication to convey the information about interactions to the application.

When a runtime environment for applications designed for a different operating system, or a cross-platform runtime environment that integrates with native-environment notifications is added to and operating system, an adaptation layer 1104 can be used to translate notifications between the two systems.

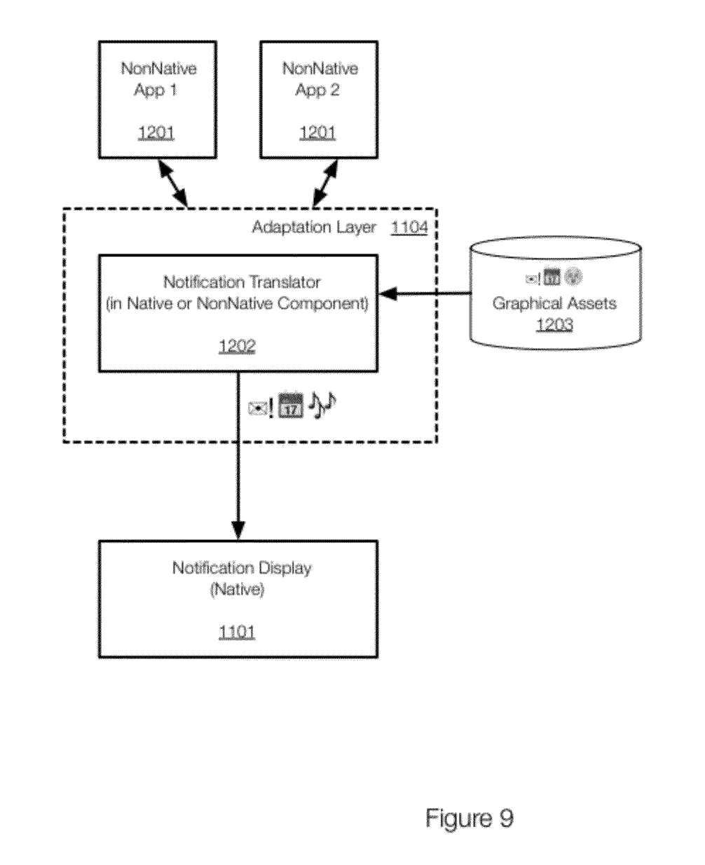

The adaptation layer 1104 provides the following functionality to facilitate adaptation:
The semantics of notification: If, for example, in the native OS, an application is brought to the foreground when a notification is acknowledged by the user, the semantics of this interaction are appropriately translated into actions on tasks in the hosted non-native environment. In the illustrated embodiment, this is effected in a manner like that shown in the FIG. 8 and discussed above in connection with coordinating foreground/active tasks as between the native and hosted runtime environments.
Interfaces: If the native environment uses a different inter-process communications mechanism (IPC) than the hosted non-native environment, the adaptation layer uses the native inter-process communications system and is a proxy for non-native applications to the native environment, and uses the non-native IPC mechanism to communicate with the non-native applications 1106.
Graphical assets: Referring to FIG. 9, if a non-native application 1201 uses the non-native API and thereby the notifications translation layer 1202 of the adaptation layer 1104 to post a notification, and if that notification either lacks a corresponding graphical asset in the native environment, non-native graphical assets 1203 that are included in the hosted runtime environment or non-native applications will be used, and, if necessary, converted to a format displayable in the native environment visual display of notifications 1101. The translation layer 1202 can be implemented in the native component and/or the non-native component of the adaptation layer 1104, as needed.

In the illustrated embodiment, adaptation layer 1104 has a non-native component and a native component which provide the aforementioned functionality. The non-native component has instructions for execution under the hosted operating system and executing on the central processing unit within one of more of the hosted runtime environments. It can communicate With the hosted notification API via the hosted IPC protocol. The native component has instructions for execution under the native operating system and executing on the central processing unit within one of more of the native runtime environments. It can communicate With the native notification API via the native IPC protocol.

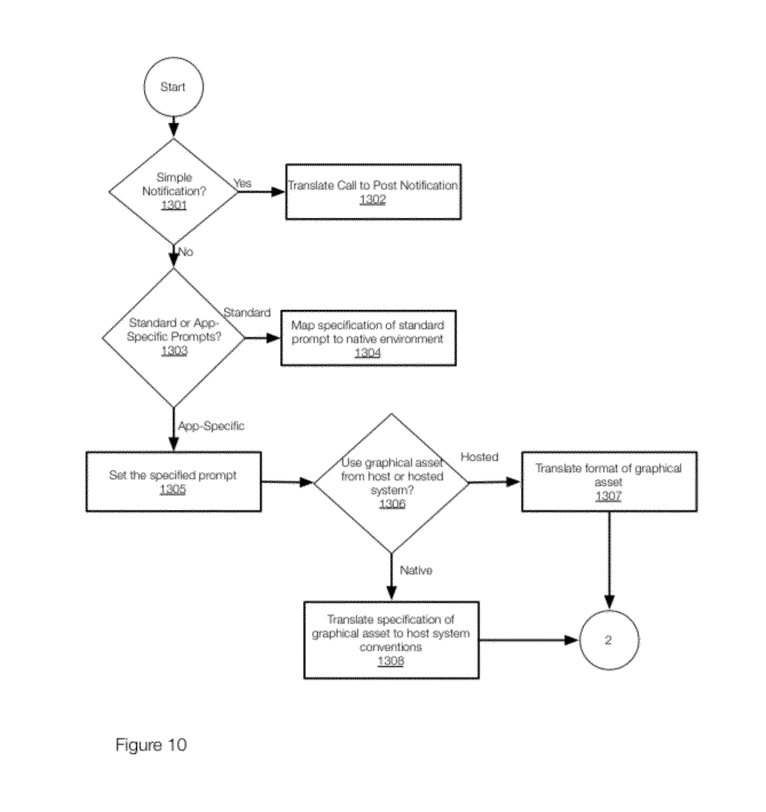

Referring to FIG. 10, when an application 1201 in the hosted, non-native environment posts a notification, the adaptation layer decides if the hosted application is posting a simple notification 1301, without graphical assets, standard prompts that need to be mapped, or a return message. If that is the case, the parameters of the hosted system's method are translated to the corresponding parameters in the host system, and the notification is posted 1302.

If the notification is not simple, then it is determined if the application is posting a notification with standard, predetermined prompt text, or with a prompt that is application-specific 1303. If the notification being posted uses a standard prompt with a counterpart in the host system, the reference to that prompt is mapped to a reference to the counterpart in the host system 1304.

If the prompt is application-specific, or if there is no counterpart to a standard prompt in the host system, the prompt text is passed to the host system to be used in the call to post the notification 1305. If there are graphical assets such as a notification icon in the notification and the asset to be used is from the hosted system 1306 any necessary format conversion is performed 1307. If a graphical asset from the host system is to be used in the notification, the specification or reference to the graphical asset is translated into one used in the host system 1308.

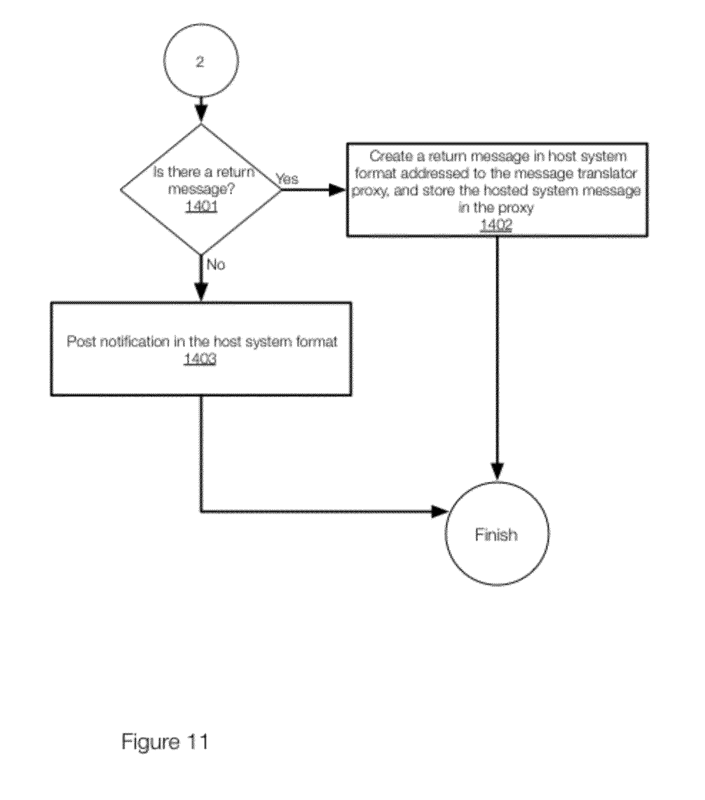

Referring to FIG. 11, if there is a message (in the hosted environment's inter-process communication (IPC) system's format) attached to the notification, to be delivered based on the user's interaction with the notification 1401, that message is registered with a proxy program with an interface to the host system's IPC system, and a message addressed to this proxy program containing a reference to the hosted system's reply message. Now the notification containing:
a prompt text, or a reference to a standard prompt in the host system,
any graphical assets that go with the message or references to host system graphical assets, and,
if present, a reply message that will be delivered to a proxy program that stores the hosted system's reply messages,

is posted 1403 to the host system's notification system.

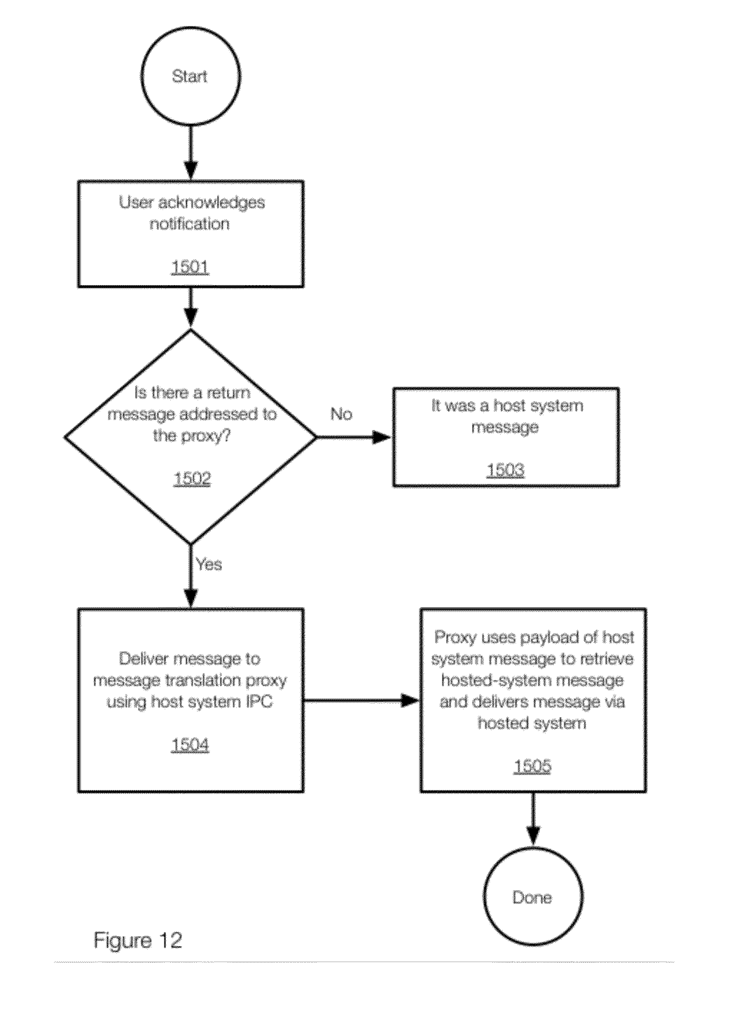

Referring to FIG. 12, if the user interacts with the notification 1501, and if the notification return message is not addressed to the proxy 1502, it is a notification for host system applications, and is processed as usual in the host system 1503. If the return message is addressed to the proxy for return messages, it is delivered to the proxy using the host system's inter-process communications mechanism 1504. The proxy uses the reference contained in the return message to find a return message registered with the proxy when the notification was posted, and this message is delivered to the hosted application, using the hosted system's IPC mechanism, as if it were sent by the hosted system's notification system 1505.

Host/Hosted Hybrid Apps in Multi-Operating System Mobile and Other Computing Devices

In other embodiments of the invention, the illustrated computing device 10 more fully merges the user experience by executing, within a single application address space, instructions comprising a hosted software application (e.g., hosted software application 34) along with instructions from the native runtime libraries 20 and/or other resources of the native runtime environments 16. Also included within that application address space can be instructions from the hosted run-time libraries 44 and/or other resources of the hosted runtime environments 32. The device 10 accomplishes this, inter alia, by linking and loading that hybrid collection of instructions into CPU (and RAM) for execution by using two linker-loaders: one for the hosted instructions and one for the native instructions, yet, both executing in the native runtime environments 16. This assumes that, although the hosted and native operating systems differ (e.g., as discussed elsewhere herein), the instructions of executables of both are suitable for execution on a like CPU—particularly, that of device 10.

Executing instructions of hosted software application 34, hosted and native runtime libraries, etc., as a hybrid application in this manner (i.e., in a single application address space) has advantages, among others, of decreasing overhead incurred in executing hosted software applications and improving the consistency of the user experience as between hosted and native software applications.

Hybrid Application

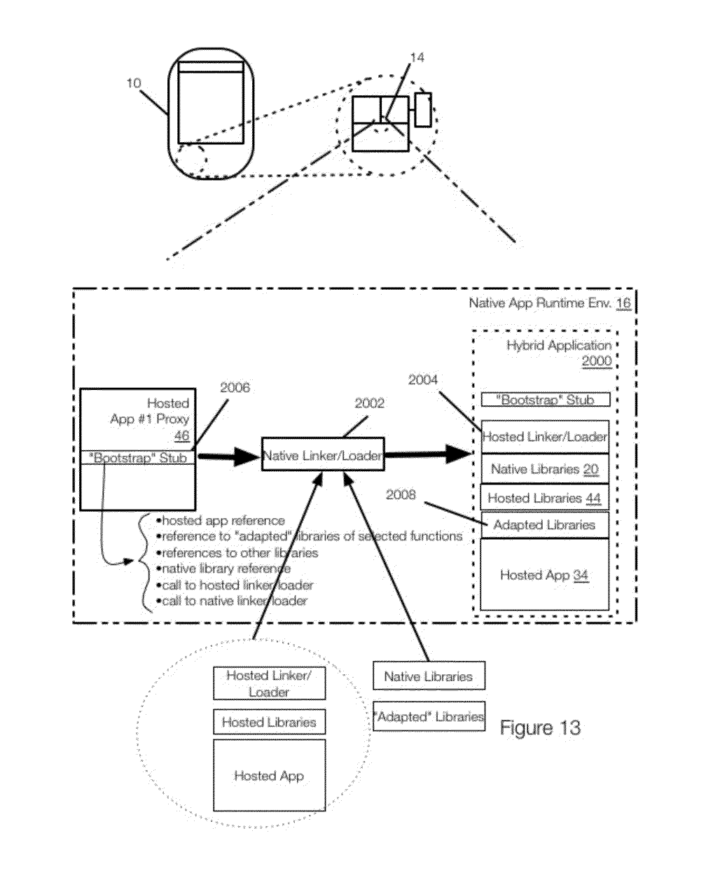

FIG. 13 depicts a hybrid collection of instructions 2000 for execution a single application address space—or, more simply put, execution of a “hybrid” application 2000—according to some embodiments of the invention.

Referring to the drawing, application 2000 executes on the CPU of device 10 within the native operating system 14. In the illustrated embodiment, the application 2000 and, more particularly, that collection of instructions is created and loaded for execution into the CPU (and RAM) of device 10 (as if it were simply comprised of instructions from a native software application and native runtime resources necessary thereto), e.g., through action of linking loaders 2002, 2004, here, labelled, native linking/loader and hosted linking/loader, respectively.

Launch Proxy/Bootstrap Stub

In the illustrated embodiment, creation and loading is initiated, for example, upon the user's selection for activation of the launch proxy 46 corresponding to the hosted software application 34 to be executed. Unlike in the embodiments discussed above (e.g., in connection with steps 66, et seq.) in which, upon launch, proxy 46 effects activation of corresponding hosted software application 34, here, creation, loading and execution of application 2000 is effected as discussed below.

The proxy 46 of the illustrated embodiment comprises code, referred to, here, as a “bootstrap stub,” that includes:
1. Instructions to link and load and execute the hosted software application 34 executable using the hosted linker/loader 2004 and, then, to execute the hosted software application 34.
2. References to one or more libraries (referred to as “adapted” libraries) containing at least selected classes and/or functions (collectively, “functions” for sake of simplicity and without loss of generality) of hosted run-time libraries 44 and/or other resources of the hosted runtime environments 32 (collectively, “hosted run-time libraries 44” for sake of simplicity and without loss of generality) called and/or potentially called by the hosted software application 34 executable.
3. References to one or more libraries containing other functions, if any, of the hosted run-time libraries 44 called and/or potentially called by the hosted software application 34 executable.
4. References to one or more native runtime libraries 20 and/or native runtime environments 16 resources.
5. Instructions for executing the hosted linker/loader 2004 with native runtime environments 16 to link hosted software application 34 and to resolve references therein using (1)-(4).

In some embodiments, rather than such references, the stub can include inline versions of (1)-(4), or a subset thereof, consistent with the teachings hereof. Of course, not all of these need be included in the bootstrap code. For example, code corresponding to item (3) and, potentially, items (2) and (3) may be absent from any particular stub.

In the illustrated embodiment, a proxy 46 comprising such code can by request from ACL 18 to native operating system 14, in connection with the installation by ACL 18 of respective hosted software application 34, e.g., consistent with the discussion above in the section entitled “Native and Hosted Software Application Installation.”

Libraries for Linking/Loading with Bootstrap Stub

The libraries referred to in (2), above, of the illustrated embodiment are adapted from conventional run-time libraries 44 of the type available in the marketplace for use under the hosted operating system and, particularly, in which at least the selected functions are modified to interface with and to utilize corresponding and/or other functions provided in native runtime libraries 20 and/or native runtime environments 16 resources. In other embodiments, some or all of those “adapted” libraries can be adapted from conventional runtime libraries 20 of the type available in the marketplace for use under the native operating system 14 and, particularly, in which at least selected functions are modified to intercept calls from the hosted software application 34 as if part of the hosted run-time libraries 44.

While those “selected” functions can include any or all functions referenced within hosted software application 34—and, indeed, can include any or all functions (regardless of whether referenced by hosted software application 34) provided within hosted run-time libraries 44—in the illustrated embodiment, the selected functions are those functions of hosted run-time libraries 44 whose execution can be more efficiently and/or beneficially executed, at least in whole or part, using from the native runtime libraries 20 and/or other resources of the native runtime environments 16. This includes, by way of nonlimiting example,
functions which, if executed on behalf of hosted software application 34 wholly in the manner conventional to the hosted operating system or hosted run-time libraries 44, might conflict with similar functionality executed within the single application address space 2000 by functions of the native runtime libraries 20 and/or other resources of the native runtime environments 16. Such functions include those for memory allocation (e.g., malloc), thread local storage, pthreads, and so forth. With respect to these functions, the adapted libraries preferably include code that is adapted from the native runtime libraries 20 so as to (i) to intercept calls from the hosted software application 34, and (ii) in the case of memory allocation functions, particularly, malloc, for example, to utilize the malloc function of the native runtime libraries 20 in lieu of that of the hosted runtime libraries 44, (iii) in the case of application threading functions, particularly, pthreads, for example, to emulate the hosted runtime library functions albeit in a manner expressible in context of native runtime library thread management, and (iv) in the case of thread local storage functions, particularly, for example, TLS, parlaying information maintained in individual entries of the vector maintained by TLS of the native runtime libraries 20 (for purposes of managing threads of individual native applications) to manage multiple threads of the hosted software application 34, all by way of nonlimiting example.
functions which can be more effectively executed utilizing hardware-specific and/or other optimizations and/or other coding features provided by the native runtime libraries 20 and/or other resources of the native runtime environments 16. Such functions include those for graphics acceleration and, more generally, for interfacing with hardware devices 24-30 integral or attached to device 10. With respect to these functions, the adapted libraries preferably include code that is adapted from the hosted runtime libraries 44 so as to (i) to redirect calls from the hosted software application 34 to more efficient and/or better optimized functions provided by the native runtime environments 16 and native runtime libraries 20.

The other functions of the hosted run-time libraries 44 referred to in (3), above, are those functions of conventional hosted run-time libraries 44 (i.e., conventional run-time libraries 44 of the type available in the marketplace for use under the hosted operating system) whose execution is not necessarily more efficiently and/or beneficially effected using from the native runtime libraries 20 and/or other resources of the native runtime environments 16. Examples include mathematical and other computationally-based functions.

The native linking/loader 2002 can be a link/loader of the type conventionally available in the marketplace (as adapted in accord with the teachings hereof) for linking and loading native software applications for execution on device 10 under hosted operating system 14. Hosted linking/loader can be of the type conventionally available in the marketplace for linking and loading hosted software applications for execution under the hosted operating system, albeit as adapted in accord with the teachings hereof for execution within native runtime environments 16.

Operation

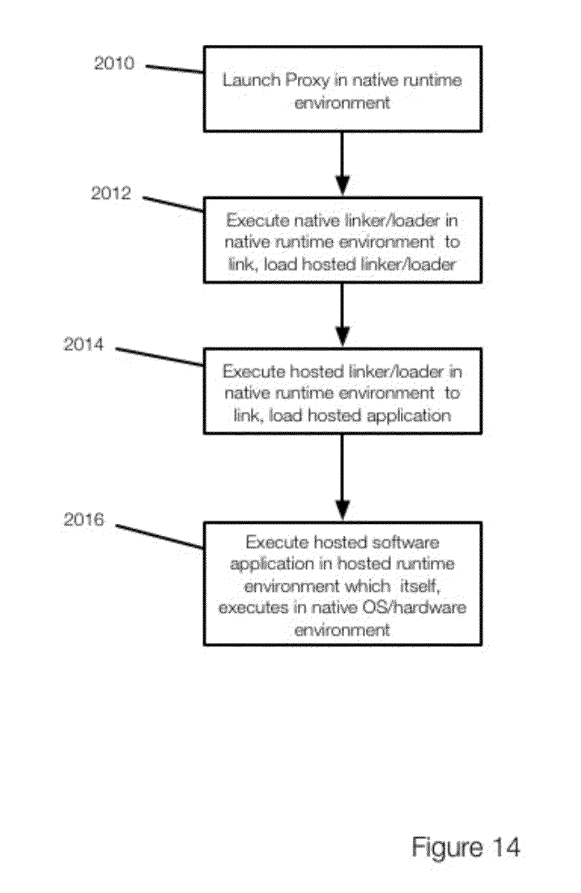

FIG. 14 is a flow chart depicting operation of device 10 in creating and executing a hybrid application 2000 in native runtime environments 16.

Referring to step 2010, upon selection of proxy 46 by the user for launch (or other notification of activation from native runtime environments 16 and/or native operating system 14), native linker/loader 2002 loads general functions necessary for application execution under native operating system 14, e.g., functions of the native runtime libraries 20 and/or other resources of the native runtime environments 16 necessary to allocate allocate and manage memory, threads and so forth, by way of nonlimiting example.

In step 2012, native linker/loader 2002 accesses the hosted linker/loader 2004, links and loads it for execution. This includes resolving references made in the code of linker/loader 2004, e.g., by linking referenced functions from the native runtime libraries 20. To the extent that code references functions of the hosted run-time libraries 44, this includes linking the adapted runtime libraries 2008, and, then, the native runtime libraries 20, so as to insure that the adapted libraries 2008 are used in preference to the conventional hosted run-time libraries 44 and to insure that any still unresolved references are satisfied by the native runtime libraries 20.

In step 2014, once the hosted linker/loader is executed, the native linker/loader 2002 relinquishes control to native operating system 14 and/or native runtime environments 16 to commence execution of the hybrid application 2000 in native runtime environments 16, beginning with the instruction to link and load the hosted software application 34 executable using the hosted linker/loader 2004. This causes the hosted linker/loader 2004 to access the hosted software application 34 executable, and to link and load it for execution. As above, this includes resolving references made in that code by linking it, first, to the code of the adapted adapted libraries 2008, then, to the code of the hosted run-time libraries 44. The hosted linker/loader 2004 can also link the native runtime libraries 20 to resolve any final unresolved references.

Referring to step 2016, the executing hybrid application 2000 next executes instructions causing the linked/loaded hosted software application 34 to execute within the native hardware environment of device 10 under the native operating system 14, using functions both from the native runtime libraries 20, the adapted libraries 2008 and the hosted run-time libraries 44.

### CONCLUSION

Described above and shown in the drawings are devices and methods meeting the desired objects, among others. Those skilled the art will appreciate that the embodiments described and shown here in our merely examples of the invention and that other embodiments, incorporating changes to those here, fall within the scope of the invention, as well.

In view thereof, what we claim is:

1. A computing device, comprising
A. a central processing unit (CPU) that is coupled to a hardware interface, including at least a display and an associated video frame buffer,
B. a native operating system executing on the CPU, the native operating system including one or more native runtime environments within which native software applications are executing, where each such native software application has instructions for execution under the native operating system, and
C. a hybrid application executing on the CPU in a single application address space established within said native operating system.

2. The computing device of claim 1, wherein the hybrid application includes (i) instructions comprising a hosted software application built and intended for execution under a hosted operating system that differs from the native operating system, and (ii) instructions from at least one of a runtime library and another resource of the native runtime environment.

3. The computing device of claim 2, wherein the single application address space additionally includes instructions from at least one of a runtime library and another resource of the hosted operating system.

4. Apparatus, systems and methods as described in the Summary of Invention and elsewhere herein.
